(19) United States
(12) Patent Application Publication
(10) Pub. No.: US 2007/0039585 A1
(43) Pub. Date: Feb. 22, 2007

(54) Valves for internal combustion engines and methods thereof

(76) Inventor: Anthony T. Rubert, Rochester, NY (US)

Correspondence Address: NIXON PEABODY LLP - PATENT GROUP, CLINTON SQUARE, P.O. BOX 31051, ROCHESTER, NY, 14603-1051, US

(21) Appl. No.: 11/588,023

(22) Filed: Oct. 26, 2006

Related U.S. Application Data
(63) Continuation-in-part of application No. 11/056,590, filed on Feb. 11, 2005.

(51) Int. Cl. F02N 3/00

(52) U.S. Cl. 123/188.3

(57) ABSTRACT

A valve for an internal combustion engine includes a valve head, a valve stem and one or more vanes. The valve head comprises a valve face and a valve back and the valve stem is connected to and extends from the valve back. One or more vanes are connected to and positioned about at least one of the valve back and the valve stem adjacent the valve head.

This application is a continuation-in-part of patent application Ser. No. 11/056,590, filed on Feb. 11, 2005, which is hereby incorporated by reference in its entirety.

### FIELD OF THE INVENTION

The present invention generally relates to internal combustion engines and, more particularly, to intake and exhaust valves for an internal combustion engine and methods thereof.

### BACKGROUND

An internal combustion engine includes one or more cylinders, each forming a combustion chamber for burning air/fuel mixtures to produce a mechanical energy. Referring to FIG. 1, an example of a four stroke cycle, internal combustion engine 10 with a piston 12 and a cylinder 14. During the intake cycle, the rotation of a cam shaft 16 causes a spring-loaded intake valve 18 to open. This enables the fuel and air mixture to flow from the carburetor or fuel injector into the combustion chamber 20 in the cylinder 14. During the compression cycle, the intake valve 18 is closed and the piston 12 compresses the fuel and air mixture in the combustion chamber 20. During the combustion cycle, the fuel and air mixture is ignited which drives the piston 12 back down the cylinder 14. During the exhaust cycle, the cam shaft 16 opens a spring-loaded, exhaust valve 22 which allows for the evacuation of exhaust gases from the combustion chamber 20.

Referring to FIGS. 1 and 2, the exhaust valve 22 in the internal combustion engine 10 includes a valve head 24 with a valve head back 26, and a valve head face 28. The valve head back 26 and valve head face 28 are separated by an annular rim portion 30. The annular rim portion 30 has a section with decreasing radius and a section with increased back angle which together make up the valve margin 32 and valve seat 34, respectively. The exhaust valve 22 also contains a cylindrical valve stem 36 which rises axially from the upper surface of the valve head 24 and which has an end with a lock groove 37 for attachment to a spring retainer lock to allow the opening and closing of the exhaust valve 22 in the internal combustion engine 10.

The valve head 24 of the exhaust valve 22 has a relatively flat valve face which is very efficient for intake valves, but is far from optimal for an exhaust valve. This is because exhaust gases, when flowing over a relatively flat valve head, are expelled from the cylinder 14 at less than optimal velocities. This, in turn, reduces the overall power obtainable by each combustion cycle, thus affecting the efficiency and speed of the internal combustion engine 10.

Basic to the efficient flow of gases over an object is the concept of laminar flow. Laminar flow is characterized by layers, or laminas, of air moving at the same velocity over an object. Laminar flow is affected by several factors, including the shape of the object over which the gas flows. Depending on the shape of an object, laminar flow may actually become turbulent flow, thus slowing the velocity of a gas over the object. This occurs because the concentric layers of flow may transfer energy from one layer to another, either accelerating or slowing the adjacent layer, which creates tumbling or turbulent flow around a specific object. This type of turbulent flow occurs to an extent when exhaust gases move out over, or past, the flat exhaust valve head 24, which reduces the overall efficiency of the internal combustion engine 10.

Airflow in most engines is only about 80% efficient, which means that at normal running speeds, the cylinders are only ⅘^{th} full. The airflow efficiency of an engine is called the volumetric efficiency of an engine. Any increase in this efficiency affords greater power to the engine. There are several restrictions to airflow within an engine, however, maximizing the flow of exhaust gases over an exhaust valve has been largely overlooked. This lack of attention to improving the flow of exhaust gases over exhaust valves is paradoxical, because an increase in volumetric efficiency can equate with increases in engine performance. This effect would be even more pronounced in high performance vehicles, where even the slightest increase in engine performance could have significant effects on the outcome of a competition.

The efficient flow of gases through an engine is also affected by the amount of carbon buildup in an engine, including buildup on intake and exhaust valves. Gasoline, one of many fuels employed in internal combustion engines, is a mixture of hundreds of hydrocarbons. Upon the combustion of gasoline, carbon dioxide, carbon monoxide, water, and heat are the primary waste products. However, because the combustion process is not 100% efficient, intermediate hydrocarbons are also produced. These intermediate hydrocarbon waste products form the basis of carbon deposits and collect over time throughout the engine. The buildup of carbon deposits on the valves, in particular the intake valve, causes incomplete sealing between the valves and the valve seats. When this occurs, small leaks between the exhaust valve and valve seat may result, allowing hot gases to escape and reducing the overall efficiency of an engine cycle. It is apparent that the efficient expulsion of exhaust gases would decrease the amount of potential carbon buildup in an engine, however, again there has been little to no attention paid to more efficient intake and exhaust valve designs.

### SUMMARY

The present invention relates to an internal combustion engine exhaust valve having a valve head that includes a valve face and a valve back, where the valve face is convex, and a valve stem attached to the valve back. The valve of the present invention also includes a rim, which is an annular portion separating the valve face and valve head, the rim having a valve sealing surface. The attached valve stem preferably rises vertically from the center of the upper surface, or back, of the valve head, and may be integrally attached or attached by welding to the valve back. The valve stem includes an aspect near the distal end of the stem for engagement with a mechanical connector for moving the exhaust valve. In one embodiment of the present invention, this aspect is a lock groove. The valve is moved in a first direction and a second direction, (up and down or back and forth), and also is capable of being rotated. The valve head of the exhaust valve of the present invention, when viewed in cross-section, has a hemi-spherical shape, a hemi-spherical hollow shape, or a crescent shape.

Another embodiment of the present invention relates to an exhaust valve assembly for an internal combustion engine that includes the exhaust valve according to the first embodiment of the present invention and a combustion chamber to be used in concert with the exhaust valve. The combustion chamber includes an intake side and an exhaust side, where the exhaust side has an exhaust port. The exhaust valve of the present invention is placed on the exhaust side of the combustion chamber, positioned with the convex valve face directed towards the intake side of the combustion chamber and the valve back directed towards the exhaust port of the combustion chamber.

The present invention in another embodiment includes an internal combustion engine which employs an exhaust valve and exhaust chamber according to the present invention.

Another embodiment of the present invention is a method of making an efficient internal combustion engine. This method involves providing an exhaust valve according to the present invention and installing the valve in an internal combustion engine, thereby making an efficient internal combustion engine.

A valve for an internal combustion engine in accordance with embodiments of the present invention includes a valve head, a valve stem and one or more vanes. The valve head comprises a valve face and a valve back and the valve stem is connected to and extends from the valve back. One or more vanes are connected to and positioned about at least one of the valve back and the valve stem adjacent the valve head.

An internal combustion engine in accordance with other embodiments of the present invention includes at least one cylinder, at least one intake valve, and at least one exhaust valve. The cylinder comprises a chamber with an intake port and an exhaust port with the intake valve positioned in the intake port and the exhaust valve positioned in the exhaust port. The intake valve is moveable between a closed position sealing the intake port and an open position exposing the intake port to provide an opening into the chamber. The exhaust valve is moveable between a closed position sealing the exhaust port and an open position exposing the exhaust port. At least one of the intake valve and the exhaust valve comprises a valve head having a valve face and a valve back, a valve stem connected to and extending from the valve back, and one or more vanes. The one or more vanes are connected to and positioned about at least one of the valve back and the valve stem adjacent the valve head.

A method of making a valve for an internal combustion engine in accordance with other embodiments of the present invention includes providing a valve head comprising a valve face and a valve back. A valve stem is connected to the valve back which extends from the valve back. One or more vanes are connected to at least one of the valve back and the valve stem and about the valve head.

A method of making an internal combustion engine in accordance with other embodiments of the present invention includes providing at least one cylinder comprising a chamber with an intake port and an exhaust port. An intake valve is positioned in the intake port and is moveable between a closed position sealing the intake port to an open position exposing the intake port to provide an opening into the chamber. An exhaust valve in the exhaust port is moveable between a closed position sealing the exhaust port to an open position exposing the exhaust port. At least one of the intake valve and the exhaust valve comprises a valve head having a valve face and a valve back, a valve stem connected to and extending from the valve back, and one or more vanes. The one or more vanes are connected to and positioned about at least one of the valve back and the valve stem adjacent the valve head.

The present invention provides intake and exhaust valves which improve the flow of an air/fuel mixture into and exhaust gas out of the chamber in a cylinder in an internal combustion engine. The improved intake of the fuel/air mixture and the expulsion of gases from the chamber provides numerous benefits including, without limitation, cleaner engines, more efficient engines, engines capable of increased horsepower, and fuel economy.

The present invention provides for cleaner engines by improving the expulsion of exhaust gases containing carbon waste products produced from the inefficient burning of hydrocarbon fuels. Gasoline, a common internal combustion engine fuel, is a mixture of hundreds of hydrocarbons. Upon combustion, carbon dioxide, carbon monoxide, water, and heat are primarily produced. However, the process is not 100% efficient, thus, upon incomplete combustion numerous other waste products are produced. These waste products form the basis of carbon buildup in engines. Over time, carbon buildup can affect the proper function of an internal combustion engine by decreasing the effective volume of an engine's combustion chambers and by creating leaks within the combustion chamber due to buildup on the intake and exhaust valves and their respective valve seats. Carbon buildup also affects the proper function of an internal combustion engine by causing valve sticking which may result in valve burning, and by triggering pre-ignition events when loosened carbon deposits are ignited. By allowing the expulsion of exhaust gases to occur more smoothly, the gases also leave the combustion chamber more quickly, which in turn, allows for less buildup of carbon deposits within engines. Thus, another benefit of the exhaust valve of the present invention over prior art valves is a cleaner engine with a longer effective life span.

The present invention also provides a more efficient internal combustion engine. Efficiency is defined herein as the amount of fuel consumption per unit of power; the higher the efficiency the less fuel required to produce a unit of power. Not all internal combustion engines are designed to operate at maximum efficiency; however, any mechanism that improves the effective combustion process increases the efficiency of an internal combustion engine. The improved intake of fuel/air and expulsion of gases, as accomplished by the present invention, improves the overall efficiency of combustion by allowing quicker fuel/air intake and less mixing of exhaust gases with the fuel and air combustion mixtures. In addition, the improved flow of the exhaust gases out of the combustion chamber due to improved laminar flow over the exhaust valve of the present invention provides the advantage of requiring less power to push the exhaust out of the cylinder, as the improved flow provides a greater scavenging effect to pull the hot gases from the combustion chamber.

The present invention also increases the potential horsepower obtainable from an internal combustion engine. Horsepower is a measure of how fast a certain amount of work can be done. Directly related to this value is torque, which is a measure of the actual amount of work that an engine can do, irrespective of how long it takes. Because of the direct relationship between torque and horsepower, a system which increases torque can increase horsepower. In an internal combustion engine, the peak torque value is achieved when the engine is inhaling the greatest amount of fuel and air into the combustion cylinder, which, when burned, makes the peak amount of cylinder pressure, and in turn, peak power. In order to achieve and maintain the maximum torque value, the waste gases must be expelled from the combustion chamber as efficiently as possible to allow the maximum charge of new fuel and air into the chamber. The present invention improves the expulsion of exhaust gases out of the combustion chamber allowing the torque peak to be increased and maintained, thereby increasing the horsepower of the engine.

The benefits of the present invention are most observable when employed with high performance vehicles. However, because the present invention provides a cleaner, more efficient, and more powerful engine, the intake and exhaust valves of the present invention may be used with all types of internal combustion engines.

### BRIEF DESCRIPTION OF THE DRAWINGS

FIG. 1 is a cross sectional side view of a prior art internal combustion engine with a prior art intake and exhaust valves;

FIG. 2 is a side view of the prior art exhaust valve shown in FIG. 1;

FIG. 3A is a partial side and partial cross-sectional view of an exhaust valve in accordance with embodiments of the present invention;

FIG. 3B is a top view of a valve head for the exhaust valve shown in FIG. 3A;

FIG. 4A is a side view of an exhaust valve in accordance with other embodiments of the present invention;

FIG. 4B is a top view of a valve head for the exhaust valve shown in FIG. 4A;

FIG. 4C is a partial side view and partial cross-sectional view of the exhaust valve shown in FIG. 4A;

FIG. 5A is a side view of an intake valve in accordance with other embodiments of the present invention;

FIG. 5B is a top view of a valve head for the intake valve shown in FIG. 5A; and

FIG. 5C is a partial side view and partial cross-sectional view of the intake valve shown in FIG. 5A.

### DETAILED DESCRIPTION

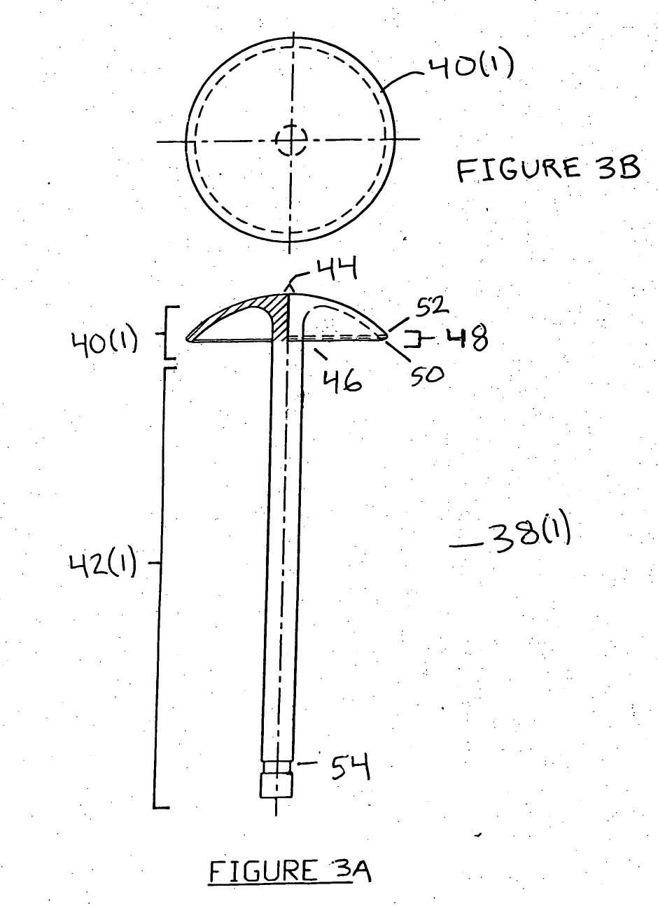

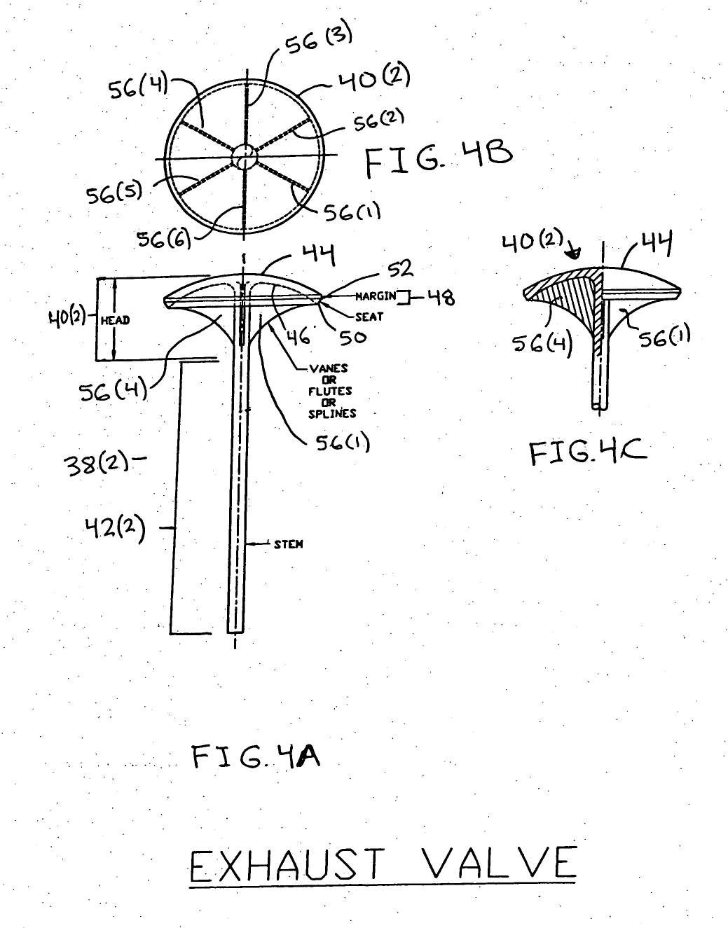

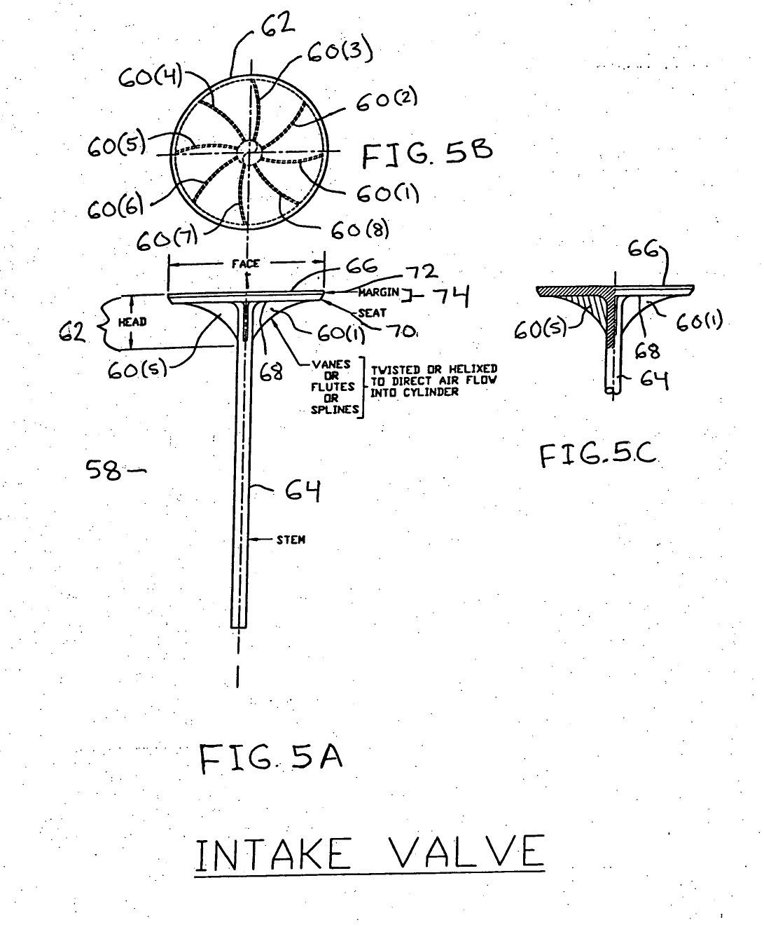

An exhaust valve 38(1) in accordance with embodiments of the present invention is illustrated in FIGS. 3A-3B. The valve 38(1) includes a valve head 40(1) and a valve stem 42(1), although the valve 38(1) could comprise other types and numbers of elements in other configurations and other types of intake and exhaust valves as shown in FIGS. 4A-4C and 5A-5C by way of example only.

The valve head 40(1) is disc-shaped, i.e., having a circular perimeter, when viewed from below, as shown in FIG. 3B. The lower surface, i.e, valve face 44 of the valve head 40(1), has a convex shape, as seen in side view, FIG. 3A. By convex shape it is meant that in all embodiments of the present invention, the center of the face of the valve head 40(1) will be higher or further out than any resting outside edge. The valve head 40(1) shape may include, without limitation, a hemi-spherical (solid or hollow) shape, a crescent-shape, wedge shape, diamond shape, tent shaped, or other tapered shape when viewed from the side or in cross-section, as in FIG. 3A. The valve head 40(1) may be overall convexo-concave, wherein the valve face 44 is convex and the valve back 46 is concave. Alternatively, the valve head 40(1) may be convexo-convex, where both the valve face 44 and the valve back 46 are convex. Some convexity of the valve back 46 will further enhance the improved exhaust gas flow provided by the convex valve face 44, and the convex shape of the valve face 44 will overcome the added weight introduced by the convexity of the valve back 46. In some embodiments of the present invention, the convexity is larger or more pronounced than in others.

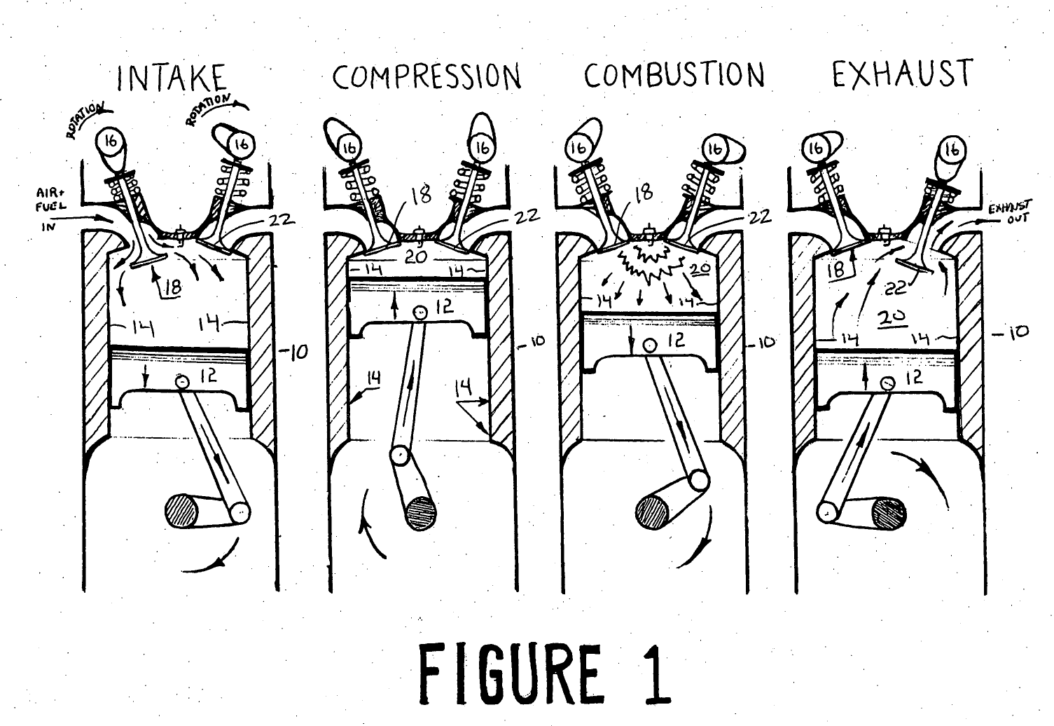

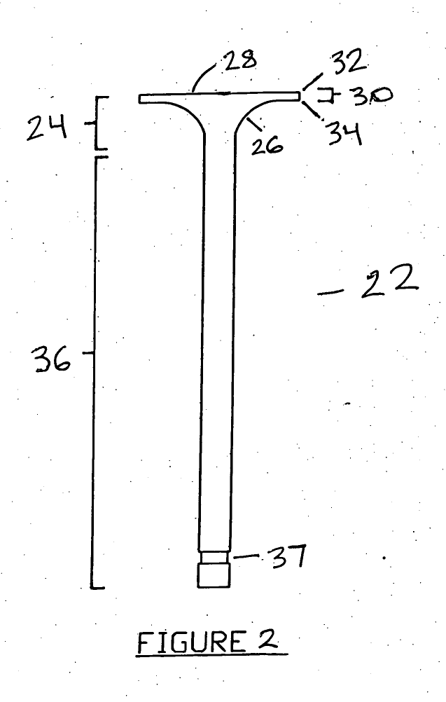

The flow of gases over an object is related to the object's shape. A surface having a hemispherical shape produces a lower coefficient of drag than flow over a flat surface. The exhaust valve 38(1) in accordance with embodiments of the present invention makes use of this property to decrease the drag coefficient of exhaust gases as they flow over the exhaust valve 38(1) into the exhaust chamber port during the exhaust cycle in an internal combustion engine, such as the one illustrated and described with reference to FIG. 1, although the valves in accordance with the present invention can be used in other types of engines.

Specifically, the exhaust valve 38(1) is designed to have a convex valve face 44 which can range in shape from slightly crescent-shaped, defined as just barely curved over flat, to a full hemisphere, when viewed in cross-section, as shown in FIG. 3A. In other embodiments, the valve back 46 is flat. In yet other embodiments the valve back 46 contours upwards to the valve stem 42(1), having a solid hemispherical or solid crescent shape. In another embodiment, the valve back 46 recedes, or angles, down from the annular rim 48 to the valve stem 42(1), which rises axially from the valve face 44. The valve face 44 is made from a range of suitable materials including, preferably, stainless steel, titanium, a titanium alloy, an iron-nickel alloy, an iron-nickel-cobalt alloy, an aluminum alloy, a cast iron alloy, or a low alloy steel, depending on the application in which the exhaust valve is employed. The surfaces of the valve face 44 and valve back 46 may be mirror-smooth (i.e, highly-polished) or may be textured, such texture ranging from slightly- to highly-dimpled.

The exhaust valve 38(1) in accordance with embodiments of the present invention also includes a valve seat 50 with a thickness and width, respectively, to form a tight leak-free seal with the exhaust chamber port when in the closed position in an internal combustion engine, such as the engine 10 shown in FIG. 1 by way of example only. The valve seat 50 may have any thickness necessary to form a tight leak-free seal with the exhaust chamber port. In one embodiment, the exhaust valve 38(1) also has a margin 52, which, together with the valve seat 50, makes up the rim 48 of the valve head 40(1) and ensures a leak-proof seal during operation.

The cylindrical valve stem 42(1) axially extends from the center of the valve back 46, and has an end distal to the valve back 46 with a connection to a mechanical member, although the valve stem 42(1) can have other shapes and other connections. The connection of the valve stem 42(1) to the mechanical member allows the exhaust valve 38(1) to be moved in a first direction and an opposing second direction, between an open and a closed position to control communication between the exhaust chamber port and the combustion chamber 20 in cylinder 14 in the engine 10 shown in FIG. 1 by way of example only. In addition, this mechanical connection allows for a rotational movement of the exhaust valve 38(1). The valve stem 42(1) has a lock groove 54 that provides for attachment to a spring retainer lock to allow the valve 38(1) to move from the open to the closed position rapidly and repeatedly, although other ways may be used to provide attachment for movement of the exhaust valve 38(1) within a combustion chamber.

In this embodiment, the valve stem 42(1) is integrally attached to the valve back 46, although the valve stem 42(1) can be connected in other manners. As used herein “integrally attached” means that the valve back 46 and valve stem 42(1) are one piece, i.e, molded, machined, or otherwise made without need of connectors or welds to hold them together. In another embodiment, the valve stem 42(1) is welded to the valve back 46.

The length and width dimensions of the exhaust valve 38(1) are determined by the application of the valve 38(1). Factors determining the dimensions of the exhaust valve 38(1) of the present invention include, without limitation, the materials from which the combustion chamber 20 is made; the shape, volume, length, and width of the combustion chamber 20; and the width and diameter of the exhaust chamber port with which the exhaust valve seat 50 forms a leak-proof interface with the combustion chamber 20. The valve stem 42(1) may be made from a range of suitable materials including, stainless steel, titanium, a titanium alloy, an iron-nickel alloy, an iron-nickel-cobalt alloy, an aluminum alloy, a cast iron alloy, or a low alloy steel.

Another embodiment of the present invention is an engine 10 with a combustion chamber 20, as shown by way of example only in FIG. 1, that includes the exhaust valve 38(1) of the present invention. The combustion chamber 20 includes an intake side and an exhaust side, the intake side having an intake valve 18 positioned therein, and the exhaust side having the exhaust valve 38(1) of embodiments of the present invention positioned therein. The exhaust side also includes an exhaust chamber port for the expulsion of hot gases when the exhaust valve 22 is in the open position in the combustion chamber 20. The combustion chamber 20 has the exhaust valve 38(1) positioned within the exhaust side of the combustion chamber 20 with the convex valve face 44 directed towards the combustion chamber 20 and the valve back 46 and valve stem 42(1) directed towards the exhaust port. The valve seat 50 may be back angled to allow a leak-proof seal with the exhaust chamber port when in the closed position. The combustion chamber 20 is manufactured so as to seal with the valve seat 50 of the valve head 40(1) when the valve face 44 has a hemi-spherical, hemi-spherical hollow, or crescent shape. The cylinder 14 which defines the combustion chamber 20 may be made from a range of materials including, but not limited to, stainless steel, titanium, a titanium alloy, an iron-nickel alloy, an iron-nickel-cobalt alloy, an aluminum alloy, a cast iron alloy, or a low alloy steel.

Referring to FIGS. 4A-4C, an exhaust valve 38(2) in accordance with other embodiments of the present invention is illustrated. The exhaust valve 38(2) is identical to the exhaust valve 38(1), except as described herein. Elements in FIGS. 4A-4C which are like elements shown in and described with reference to FIGS. 3A and 3B will have like reference numerals and will not be described in detail here again.

The exhaust valve 38(2) includes a plurality of vanes 56(l)-56(6) which are evenly spaced around the valve head 40(2), although other types and numbers of vanes with other spacing arrangements could be used, such as using flutes or splines. Each of the vanes 56(1)-56(6) is secured along one edge to the valve back 46 and along another edge to the valve stem 42(2), although each of the vanes 56(1)-56(6) could be secured in other manners. Another edge of each of the vanes 56(1)-56(6) has a concave shape extending between the valve seat 50 and the valve stem 42(2), although this edge could have other shapes and configurations. The vanes 56(1)-56(6) also have a substantially straight planar shape, although each of the vanes 56(1)-56(6) could have other shapes, such as a twisted or helix shape as shown in the vanes 60(1)-60(8) for the intake valve 58 as shown in FIG. 5B by way of example only. Additionally, in this embodiment the valve stem 42(2) is attached to a spring retainer lock to allow the valve 38(2) to move from the open to the closed position rapidly and repeatedly in manners well known to those of ordinary skill in the art.

As described herein, the design for the exhaust valve 38(1) shown in FIGS. 3A and 3B in accordance with embodiments of the present invention provides great air flow results at initial opening of the valve and up to 0.300″. Unfortunately, at larger openings or higher lifts, air flow around the exhaust valve 38(1) suffers or loses efficiency because the back or concave side 46 of this valve 38(1) causes enough turbulence which hinder air flow at higher lifts. This has a negative impact on performance.

The exhaust valve 38(2) in accordance with other embodiments of the present invention overcomes these drawbacks through the use of the vanes 56(1)-56(6). With these vanes 56(1)-56(6), the benefits of improved gas flow are maintained past valve openings of 0.300″.

Referring to FIGS. 5A-5C, an intake valve 58 in accordance with other embodiments of the present invention is illustrated. The intake valve 58 includes a valve head 62 and a valve stem 64, although the intake valve could comprise other types and numbers of elements in other configurations.

The valve head 62 is disc-shaped, i.e., having a circular perimeter, when viewed from below, as shown in FIG. 5B. The valve face 66 of the valve head 62 has a substantially flat shape as shown in FIG. 5A, although the valve face 66 could have other shapes. The valve back 68 also has a substantially flat shape, although the valve back 68 could have other shapes, such as hemispherical. The valve face 66 is made from a range of suitable materials including, preferably, stainless steel, titanium, a titanium alloy, an iron-nickel alloy, an iron-nickel-cobalt alloy, an aluminum alloy, a cast iron alloy, or a low alloy steel, depending on the application in which the intake valve 58 is employed. The surfaces of the valve face 66 and valve back 68 may be mirror-smooth (i.e., highly-polished) or may be textured, such texture ranging from slightly- to highly-dimpled.

The intake valve 58 also includes a valve seat 70 with a thickness and width, respectively, to form a tight leak-free seal with the intake chamber port when in the closed position in an internal combustion engine, such as the engine 10 shown in FIG. 1 by way of example only. The valve seat 70 may have any thickness necessary to form a tight leak-free seal with the intake port. In one embodiment, the intake valve 58 also has a margin 72, which, together with the valve seat 70, makes up the rim 74 of the valve head 62 and ensures a leak-proof seal during operation.

The valve stem 64 is cylindrically shaped and axially extends from the center of the valve back 68 as shown in FIG. 5C, and has an end distal to the valve back 68 with a connection to a mechanical member, although the valve stem 64 can have other shapes and other connections. The connection of the valve stem 64 to the mechanical member allows the intake valve 58 to be moved in a first direction and an opposing second direction, between an open and a closed position to control communication between the intake port and the combustion chamber 20 in cylinder 14 in the engine 10 as shown in FIG. 1 by way of example only. In addition, this mechanical connection allows for a rotational movement of the intake valve 58.

In this embodiment, the valve stem 64 is integrally attached to the valve back 68, although the valve stem 64 can be connected in other manners. As used herein “integrally attached” means that the valve back 68 and valve stem 64 are one piece, i.e., molded, machined, or otherwise made without need of connectors or welds to hold them together. In another embodiment, the valve stem 64 is welded to the valve back 68.

The length and width dimensions of the intake valve 58 are determined by the application of the valve 58. Factors determining the dimensions of the intake valve 58 of the present invention include, without limitation, the materials from which the combustion chamber 20 is made; the shape, volume, length, and width-of the combustion chamber 20; and the width and diameter of the intake port with which the intake valve seat 70 forms a leak-proof interface with the combustion chamber 20. The valve stem 64 may be made from a range of suitable materials including, stainless steel, titanium, a titanium alloy, an iron-nickel alloy, an iron-nickel-cobalt alloy, an aluminum alloy, a cast iron alloy, or a low alloy steel.

Another embodiment of the present invention is an engine 10 with a combustion chamber 20, as shown by way of example only in FIG. 1, that includes the intake valve 58. The combustion chamber 20 includes an intake side and an exhaust side, the intake side having an intake valve 58 positioned therein, and the exhaust side having the exhaust valve 38(1) or 38(2). The intake side also includes an intake port for the introduction of the air/fuel mixture into the combustion chamber 20 when in the open position. The combustion chamber 20 has the intake valve 58 positioned within the intake side of the combustion chamber 20 with the valve face 66 directed towards the intake side of the combustion chamber 20 and the valve back 68 and valve stem 64 directed towards the intake port. The valve seat 70 may be back angled to allow a leak-proof seal with the intake port when in the closed position. The combustion chamber 20 is manufactured so as to seal with the valve seat 70 of the valve head 62.

The intake valve 58 includes a plurality of vanes 60(1)-60(8) which are evenly spaced around the valve head 62, although other types and numbers of vanes with other spacing arrangements could be used, such as using flutes or splines. Each of the vanes 60(1)-60(8) is secured along one edge to the valve back 68 and along another edge to the valve stem 64, although each of the vanes 60(1)-60(8) could be secured in other manners. Another edge of each of the vanes 60(1)-60(8) has a concave shape extending between the valve seat 70 and the valve stem 64, although this edge could have other shapes and configurations. The vanes 60(1)-60(8) also have a twisted or helix shape, although each of the vanes 60(l)-60(8) could have other shapes, such as a substantially straight shape as shown in the vanes 56(1)-56(6) for the exhaust valve 38(2). Additionally, in this embodiment the valve stem 64 is attached to a spring retainer lock to allow the valve 58 to move from the open to the closed position rapidly and repeatedly in manners well known to those of ordinary skill in the art

The present invention includes a method of increasing the efficiency and horsepower of an internal combustion engine by providing the intake valve and/or the exhaust valve according to embodiments of the present invention and installing them in an internal combustion engine. The efficiency of an engine may be described in terms of the amount of fuel needed in order to produce a specific amount of power. Specifically, the higher the efficiency, the less fuel required to produce a unit of power. Among the factors that can affect the efficiency of an engine is the airflow within the engine which, in most cases, is only about 80% efficient. There are numerous restrictions to airflow within an engine including the air cleaner, throttle plates, bends in the manifold, intake valves, and exhaust valves. Each of these engine components slows the airflow into and out of the cylinder, all of which decrease the efficiency of an engine.

The present invention provides embodiments for improved intake and exhaust valves, as shown in FIGS. 3A, 3B, 4A, 4B, 4C, 5A, 5B, and 5C, which allows for the improved intake into the chamber of the air/fuel mixture and the improved expulsion of exhaust gases from the combustion chamber. This is achieved with the vanes on the intake valve and the vanes and the convex exhaust valve face on the exhaust valve which provide for a smooth flow of air/fuel mixture into the chamber and a smooth, laminar flow of exhaust gases past the exhaust valve and out of the combustion chamber. With respect to the intake valve, the use of the vanes directs the incoming air/fuel mixture into a swirl motion to fill the chamber in the cylinder more efficiently and keeps fuel molecules suspended longer. With respect to the exhaust valve, the vanes and the convex exhaust valve face on the exhaust valve improve the movement of exhaust gases, eliminates the turbulence at the valve back, and more efficiently directs the exhaust gases into and along the exhaust port. As a result, the airflow out of the engine is increased and the overall efficiency of the engine can be maximized.

In addition, the intake valve and the exhaust valve of the present invention increase the effective horsepower of an internal combustion engine. Horsepower is directly related to engine torque which is related to the amount of airflow through an engine. When the volumetric efficiency of an engine is increased, torque is increased and, in turn, the horsepower of the engine increases. When the intake valve and the exhaust valve of the present invention are used in an internal combustion engine, the vanes on the intake and exhaust valves and the shape of the exhaust valve face allows the air/fuel mixture to more efficiently enter the chamber and enables the exhaust gases to flow more quickly out of the combustion chamber. This will allow more fuel and air to enter the chamber during the intake stroke of the combustion cycle, thus increasing the potential torque and subsequent horsepower. This improved flow of the air/fuel mixture in and the exhaust gases out increases the volumetric efficiency of the engine, thus increasing the torque of the engine and, subsequently, horsepower.

The improved intake and exhaust valves of the present invention are suitable for use in any vehicle powered by an internal combustion engine having one or more cylinders. For example, they may be installed in airplanes; automobiles, including, but not limited to, high performance automobiles; trucks; motorcycles; recreational vehicles including all terrain vehicles, motor boats, snow mobiles, jet skis, and wave runners; tractors, lawn mowers, and air compressors.

The foregoing description of the specific embodiments will so fully reveal the general nature of the present invention that others skilled in the art can, by applying current knowledge, readily modify or adapt for various applications such specific embodiments without undue experimentation and without departing from the generic concept, and therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of forms without departing from the invention.

What is claimed is:

1. A valve for an internal combustion engine, the valve comprising:
a valve head comprising a valve face and a valve back;
a valve stem connected to and extending from the valve back; and
one or more vanes connected to and positioned about at least one of the valve back and the valve stem adjacent the valve head.

2. The valve as set forth in claim 1 wherein at least one of the one or more vanes has a substantially straight shape which extends along a length of the valve stem.

3. The valve as set forth in claim 1 wherein at least one of the one or more vanes has a helix shape which extends along a length of the valve stem.

4. The valve as set forth in claim 1 wherein the valve face has a convex shape.

5. The valve as set forth in claim 1 wherein the valve face has at least one of a substantially flat shape and a substantially concave shape.

6. The valve as set forth in claim 1 further comprising a plurality of the one or more vanes.

7. An internal combustion engine comprising:
at least one cylinder comprising a chamber with an intake port and an exhaust port;
an intake valve positioned in the intake port, wherein the intake valve is moveable between a closed position sealing the intake port to an open position exposing the intake port to provide an opening into the chamber;
an exhaust valve positioned in the exhaust port, wherein the exhaust valve is moveable between a closed position sealing the exhaust port to an open position exposing the exhaust port;
wherein at least one of the intake valve and the exhaust valve comprises a valve head having a valve face and a valve back, a valve stem connected to and extending from the valve back, and one or more vanes connected to and positioned about at least one of the valve back and the valve stem adjacent the valve head.

8. The engine as set forth in claim 7 wherein at least one of the one or more vanes has a substantially straight shape which extends along a length of the valve stem.

9. The engine as set forth in claim 7 wherein at least one of the one or more vanes has a helix shape which extends along a length of the valve stem.

10. The engine as set forth in claim 7 wherein the valve face of the exhaust valve has a convex shape.

11. The engine as set forth in claim 7 wherein the valve face of the intake valve has at least one of a substantially flat shape and a substantially concave shape.

12. The engine as set forth in claim 7 further comprising a plurality of the one or more vanes.

13. A method of making a valve for an internal combustion engine, the method comprising:
providing a valve head comprising a valve face and a valve back;
connecting a valve stem to the valve back which extends from the valve back; and
connecting one or more vanes to at least one of the valve back and the valve stem and about the valve head.

14. The method as set forth in claim 13 wherein at least one of the one or more vanes has a substantially straight shape which extends along a length of the valve stem.

15. The method as set forth in claim 13 wherein at least one of the one or more vanes has a helix shape which extends along a length of the valve stem.

16. The method as set forth in claim 13 wherein the valve face has a convex shape.

17. The method as set forth in claim 13 wherein the valve face has at least one of a substantially flat shape and a substantially concave shape.

18. The method as set forth in claim 13 further comprising a plurality of the one or more vanes.

19. A method of making an internal combustion engine, the method comprising:
providing at least one cylinder comprising a chamber with an intake port and an exhaust port;
positioning an intake valve in the intake port, wherein the intake valve is moveable between a closed position sealing the intake port to an open position exposing the intake port to provide an opening into the chamber;
positioning an exhaust valve in the exhaust port, wherein the exhaust valve is moveable between a closed position sealing the exhaust port to an open position exposing the exhaust port;
wherein at least one of the intake valve and the exhaust valve comprises a valve head having a valve face and a valve back, a valve stem connected to and extending from the valve back, and one or more vanes connected to and positioned about at least one of the valve back and the valve stem adjacent the valve head.

20. The method as set forth in claim 19 wherein at least one of the one or more vanes has a substantially straight shape which extends along a length of the valve stem.

21. The method as set forth in claim 19 wherein at least one of the one or more vanes has a helix shape which extends along a length of the valve stem.

22. The method as set forth in claim 19 wherein the valve face of the exhaust valve has a convex shape.

23. The method as set forth in claim 19 wherein the valve face of the intake valve has at least one of a substantially flat shape and a substantially concave shape.

24. The method as set forth in claim 19 further comprising a plurality of the one or more vanes.
